(19) United States
(12) Patent Application Publication
(10) Pub. No.: US 2003/0079050 A1
(43) Pub. Date: Apr. 24, 2003

(54) Computer system with parallel sever architecture

(76) Inventors: Cheng Tsung Chang, Tao Yuan Hsien (TW); Chao Kang Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/981,726

(22) Filed: Oct. 19, 2001

(51) Int. Cl. G06F 13/10; G06F 9/00

(52) U.S. Cl. 709/321; 709/328

(57) ABSTRACT

A computer system with parallel sever architecture comprises a common device driver unit for managing the I/O interface of at least one common device of the computer system; at least one application module unit runnable on the computer system and comprising hardware and software to perform certain function with the help of the common device in the common device driver unit; and a message exchange unit functioned as message interface of the common device driver unit and the application module unit. The common device driver unit is in same hierarchy as the application module unit. The communication between the common device driver unit and the application module unit is controlled by the message exchange unit rather than direct connection.

### FIELD OF THE INVENTION

The present invention relates to a computer system with parallel sever architecture, especially to a mobile computer system wherein the operation system and application programs are designed apart.

### BACKGROUND OF THE INVENTION

The development of conventional operation systems and application programs are based on existing computer hardware. As the diversity of product is increased and the development term is reduced, the stress is laid on reuse of developed resource and expertise cooperation.

For example, the mobile electronic devices and system have great diversity and the architecture of the conventional operation system, software and hardware are not suitable for this electronic device and system. FIG. 1 shows a block diagram of a conventional operation system. The current operation systems are almost modified or derived from this system. As shown in this figure, the conventional operation system mainly comprises an operation system kernel 1 as a control center of this system, a device driver 2 composed of related software and hardware and controlled by the kernel 1, a plurality of common devices 3 controlled by the device driver 2 and an application unit 4 controlled by the device driver 2. The conventional operation system is a layered hierarchy composed of the kernel 1, the device driver 2 and the application unit 4 from top layer to bottom layer.

As FIG. 1 shown, if a common device 3 is added into or removed from the computer, the device driver 2 should be modified also, i.e., certain driver program should be installed into or uninstalled from the device driver 2. The development of the driver program is labor- and time-consuming job. Moreover, application unit 4 is also modified if a common device 3 is added into or removed from the computer. Although the systems with Plug and Play and Hot Plug are very popular last years, it still isn't ideal and need the support of the application unit 4.

If the kernel 1 is modified, the device driver 2 and the application unit 4 should be modified also, or even modified the CPU, for better performance. The philosophy of conventional development in operation system is stressed on the kernel 1, while the functions of the application programs and peripheral hardware are often sacrificed. However, for a client-oriented system such as a mobile electronic product, the application programs and peripheral hardware are important. Therefore, the operation system should be designed with more stress on application programs and peripheral hardware aspect.

FIG. 2 shows a schematic diagram of an operation system in timesharing operation. Each of the application programs in this operation system is referred to one of tasks 41. The system resource is managed by the operation system and allocated for each task 41. However, the available resource and the detail of resource allocation are unknown to each task 41. If several tasks 41 are designed to use same system resource and the kernel 1 is not designed for this situation and the application programs of the several tasks 41 don't consider the time-out issues, a deadlock problem may occur. Therefore, this kinds of application programs should be subjected to a series of tests under this operation system to ensure normal and compatible operation. However, the application programs for mobile electronic products can't bear the dead lock problem. They do not have much system resource and can't execute such many program codes to prevent deadlock problem. For example, a walkman has a processor therein. It will be a nightmare to user if the processor of the walkman is down frequently.

The developments of products under architecture of conventional operation system are limited, mainly due to the structure of operation system, application program and integrated type chip. The inventor has summarized several design issues for mobile electronic products:

1. Compact and personalized.

2. Diverse and versatile.

3. Short development term and long product life.

4. Easy to develop and be supported.

5. The operation system should be easy to learn and CPU-independent.6. The developed resource should be reused for saving cost and labor.

### SUMMARY OF THE INVENTION

An object of the present invention is to provide a computer system with parallel sever architecture, wherein the operation system and application program of the computer system are in parallel status, i.e., they have the same status. The hardware and software of the computer system can be independently developed to save cost and time.

Another object of the present invention is to provide a computer system with parallel sever architecture, wherein the operation system and application program of the computer system are apart and have no direct connection. Therefore, the replacement of hardware and software of the computer system only has very small influence to the computer system.

Another object of the present invention is to provide a computer system with parallel sever architecture, wherein it has security, anti-copying and anti-virus feature.

Another object of the present invention is to provide a computer system with parallel sever architecture, wherein it has excellent expansion ability.

Another object of the present invention is to provide a computer system with parallel sever architecture, wherein it has hardware and software with high replaceable feature. The risk of update and replacement can be reduced.

To achieve above objects, the present invention provides a computer system with parallel server architecture comprising at least a common device driver unit for managing the I/O interface of at least one common device of the computer system; at least one application module unit runnable on the computer system and comprising hardware and software to perform certain functions with the help of the common device in the common device driver unit; and a message exchange unit functioned as message interface of the common device driver unit and the application module unit. The common device driver unit is in same hierarchy as the application module unit. The communication between the common device driver unit and the application module unit is controlled by the message exchange unit rather than direct connection. The various objects and advantages of the present invention will be more readily understood from the following detailed description when read in conjunction with the appended drawings.

### BRIEF DESCRIPTION OF DRAWING

FIG. 1 shows a block diagram of a conventional operation system;

FIG. 2 shows a schematic diagram of an operation system in timesharing operation;

FIG. 3 shows a schematic diagram of the computer system with parallel sever architecture according to the present invention;

FIG. 4 shows a schematic diagram of the computer system with parallel sever architecture in operation;

FIG. 5 shows a schematic diagram of the inventive computer system with parallel sever architecture for multi-task operation

FIG. 6 shows the preferred embodiment of the present invention, wherein an MP3 player is demonstrated;

FIG. 7 also shows the preferred embodiment of the present invention, wherein an MP3 player is demonstrated;

FIG. 8 also shows the preferred embodiment of the present invention; and

FIG. 9 shows the preferred embodiment of the present invention, wherein an ADPCM player is demonstrated.

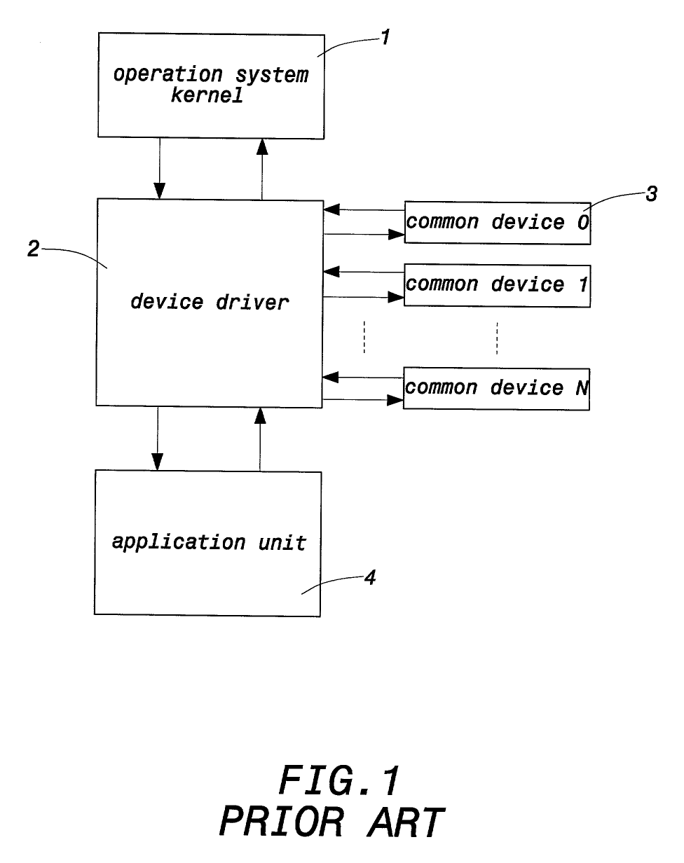

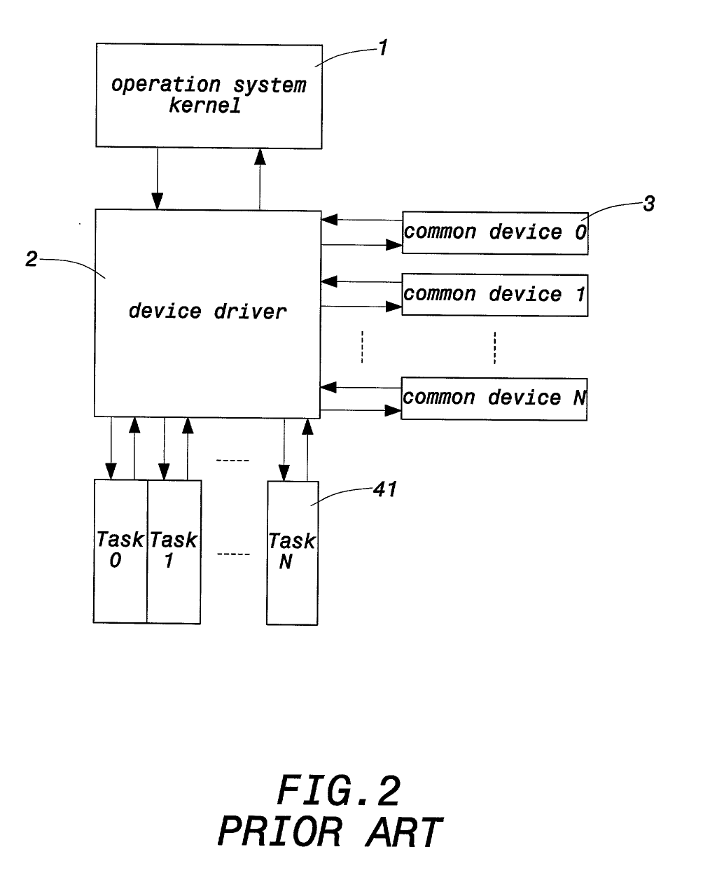

### DETAILED DESCRIPTION OF THE INVENTION

The present invention is intended to provide a computer system with parallel sever architecture. The term “parallel” does not mean that a plurality of processors is used to execute one task. The term “parallel” means that the operation system and application program of the computer system are in parallel status, i.e., of same hierarchy. The operation system and application program of the computer system are severed and have no direct connection. The replacement of hardware and software of the computer system has no influence to the computer system. Therefore, the design flow according to the present invention is from application program to hardware and then to operation system, rather than from hardware to operation system and then to application program.

The design flow according to the present invention is client-oriented and the design effort can be reduced. The designer can choose operation system suitable to his designed application program. Therefore, the operation system is of less priority for consideration, even becomes an optional equipment. Moreover, the hardware and software of the computer system can be independently developed to save cost and time.

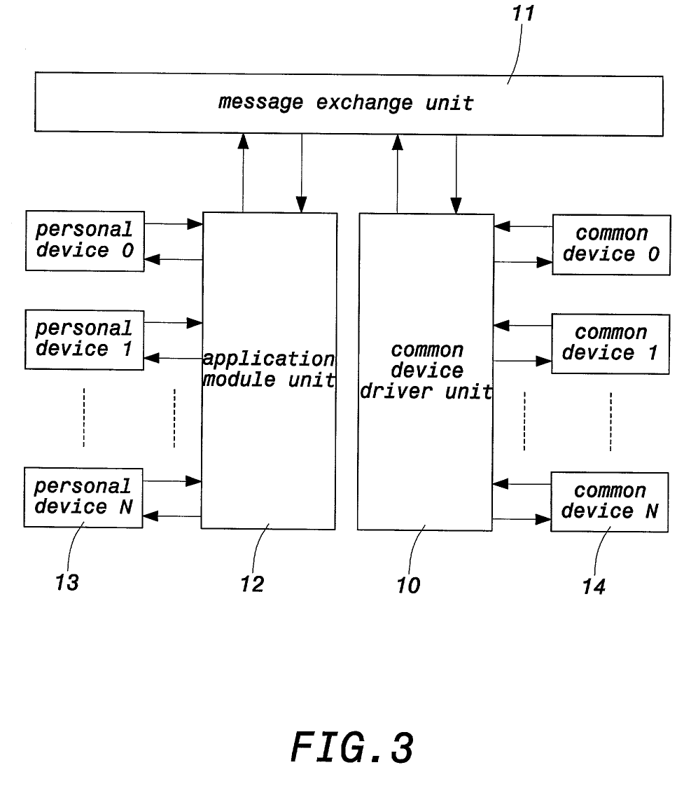

As shown in FIG. 3, the computer system with parallel sever architecture mainly comprises CPU, memory and I/O interface. The computer operation system according to the present invention mainly comprises a common device driver unit 10 for managing the I/O interface of the common devices 14 of a computer system, at least one application module unit 12 runnable on the computer system and comprising hardware and software to perform certain function with the help of the common device in the common device driver unit, and a message exchange unit 11 functioned as message interface of the common device driver unit 10 and the application module unit 12. The computer system with parallel sever architecture according to the present invention has following features:

1. The common device driver unit 10 replaces the kernel in conventional operation system. Therefore, the common device driver unit 10 can be accounted the operation system of the computer system.

2. The communication between the common device driver unit 10 and the application module unit 12 is controlled by the message exchange unit 11 rather than conventional functional call. Therefore, the common device driver unit 10 and the application module unit 12 have no direct connection.

3. There is no device driver 2 provided. The functional control of the application is achieved by the personal device 13 of the application module unit 12 or the common device 14 of the common device driver unit 10.

4. Each application module unit 12 has specific control function for its personal device 13. It is not necessary to install a specific device driver to the common device driver unit 10.

5. All messages are transmitted through the message exchange unit 11. The unauthorized data is not available.

6. It is not necessary for the application module unit 12 and the common device driver unit 10 to use same CPU, because the common device driver unit 10 and the application module unit 12 have no direct connection.

7. both of the common device driver unit 10 and the application module unit 12 are able to be integrated into a chip or modularized.

8. The other system resource such as memory manage unit (MMU), graphic user interface (GUI) are dissolved into the common device driver unit 10, which replaces the function of operation system.

Therefore, the operation system is used as service function in this invention rather than supervise function. More particularly, the common device driver unit 10 can be deemed as a service task for a common device 14 and used for I/O management of the common devices 13 of entire system. To access the common device 14, the application module unit 12 issues a request to the common device driver unit 10 through the message exchange unit 11. The common device driver unit 10 schedules the request and replies the request by priority.

The service module provided by the common device driver unit 10 can reduce the development effort of hardware and application software, wherein the allocation of system resource can be neglected. The allocation of system resource is hardest task in development of operation system. Moreover, the instructions of the hardware and application software thus developed can be modularized and the inventive operation system can be realized by chip. Various CPU can be embedded into the system using the computer system with parallel sever architecture without increasing the effort of re-developing hardware and application software.

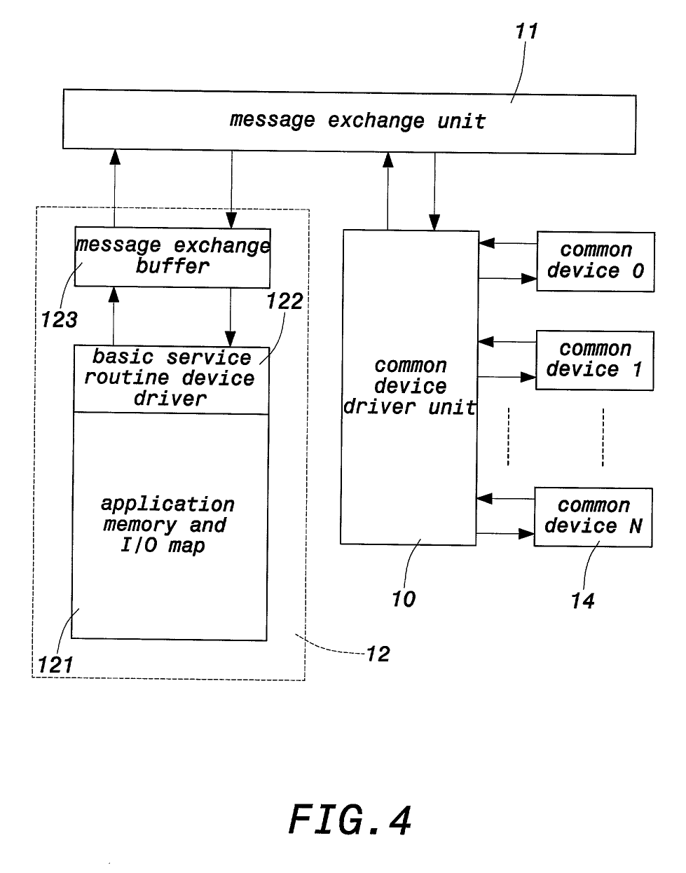

FIG. 4 shows a schematic diagram of the computer system with parallel sever architecture in operation. In the present invention, an application module unit 12 occupies all resource of CPU in its operation. However, the application module unit 12 can be processed by an external CPU, wherein the task executed by the CPU exchanges message with the common device driver unit 10. The common device driver unit 10 is also a personal device. The application module unit 12 further has an application memory and I/O map 121 and a basic service routine device driver 122 for providing auxiliary functions to access all the functions provided by the common device driver unit 10. The auxiliary functions include file system and graphical user interface (GUI) to communicate with the common device driver unit 10.

In the present invention, the operation system retrogresses to be a service task, the common device driver unit 10, which is in same hierarchy as the application module unit 12. The task executed by the common device driver unit 10 is different to the application tasks of the application module unit 12 in following aspects:

1. All the common devices and default peripheral or default driver are provided by the service task executed by the common device driver unit 10. The service task is shared by the personal devices of the application module unit 12, even though the common device driver unit 10 has different CPU with that of the application module unit 12. In other word, if a product intends to access the computer system with parallel sever architecture of the present invention, the required functions of the product should be supported by the services already provided by operation system. For example, if a product B provides service tasks such as keyboard, display, handwriting input device and storage unit, and a product A requires the service task of keyboard, display and storage unit, the product A can access the service tasks provided by product B. If the product B provides only service tasks of keyboard and display, the product A can not rely only on the service tasks provided by product B.

This design philosophy has great impact on future information industry, especially to integrated-type IC. The major market share of current integrated-type IC is PDA. According to the present invention, the integrated-type IC can be used for service task and the operation system can be integrated into a chip.

2. The development of the service task is similar to the development of the application program rather than the development of operation system. To develop the service task, the message exchange unit 11 reads request message from the application module unit 12 and the message is sent back to the application module unit 12 after the request of the application module unit 12 is processed. The message of the application module units 12 can be read in sequence or read according to priority condition. In any event, the processed message is sent back to the application module unit 12 to form a message exchange loop.

In this way, the service task can be easily developed without the problem of deadlock. The computer system with parallel sever architecture of the present invention does not need to involve some components in conventional operation system such as MMU and GUI, because that all tasks are linked through a message exchange buffer 123. Therefore, those tasks are isolated from each other except message exchange.

The file system is also optional. The basic service routine device driver 122 has a file system routine for the application module unit 12. The file system provided by the basic service routine device driver 122 is sufficient for the tasks of the application module unit 12. For example, a MP3 decoder requires only the MP3 data in a service task and it does not require a file system. The decoding operation of MP3 is performing by loading MP3 decoding program and MP3 data to the memory of the application module unit 12. The design principle of severance reduces complexity of overall system and provides maximum resource and capability to the application module unit 12.

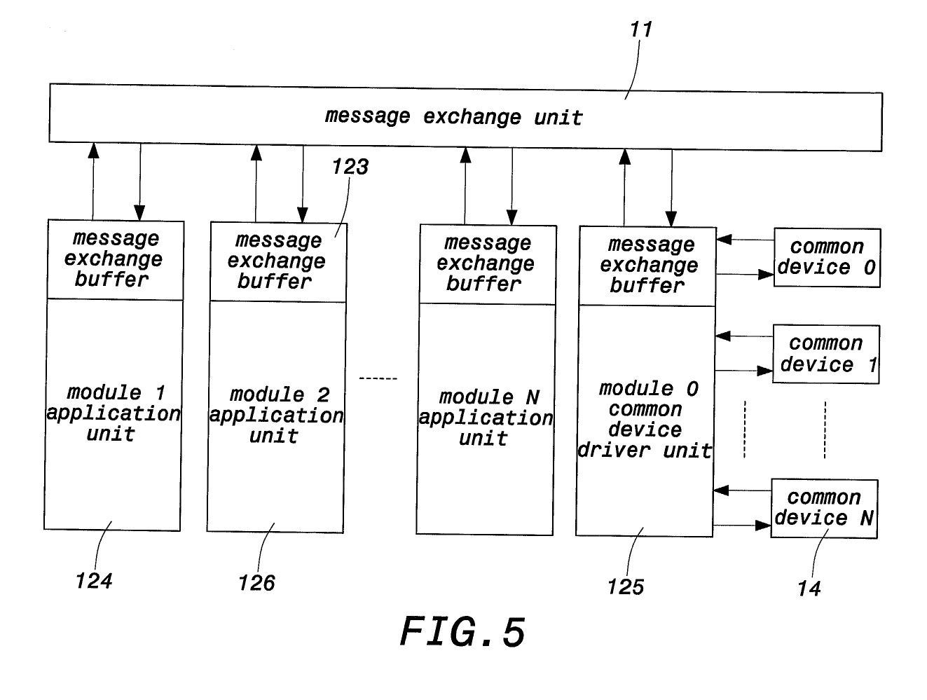

FIG. 5 shows a schematic diagram of the inventive computer system with parallel sever architecture for multi-task operation. All modules communicate to each through the message exchange buffers 123 and the message exchange unit 11. The service task 125 is the only invariant task in this invention. The message exchange buffers 123 of the tasks are separated to each other. Therefore, the task 124 cannot access data in the task 126 without the permission of the task 126. Moreover, the tasks can be executed by different CPUs. Therefore, the tasks may not be infected by virus or hacker program from other task.

The conventional operation system is constructed in layer architecture in top down fashion. The overall system may be influenced when one application program or part of the operation system is dumb. If one application program is dumb, the problem can be solved by closing the program because the application program is located at bottom of this layer architecture. If the operation system is dumb, the overall system may be crushed because the operation system is located at top of this layer architecture. However, in the present invention, the crashing of one component will not influence the overall system due to sufficient severance between those components. If one service task is crushed, the problem can be solved by restarting the service task. The components of the whole system are severed and communicate only through the message exchange unit 11. If one application program is crushed, the problem can be solved by restarting the application program. The service task has not dominant power as conventional operation system and is used to provide service only. Therefore, the computer system with parallel sever architecture of the present invention can be provided with backup service task and fault-tolerance service task to replace a main service task once the main service task is crushed. The main service task can take over the service jobs after it is restarted. Therefore, the present invention provides a computer system with parallel sever architecture to provides more safety to certain condition.

In the present invention, some device drivers are hidden in the application program. The device drivers of the service tasks are similar to the conventional device drivers. However, the device drivers of the service tasks can also be deemed as application programs in the service tasks.

For example, if a module is formed on an IC card and the IC card is connected to a system using the inventive computer system with parallel sever architecture, the driver program of the IC card is developed as an application programs. The software for the IC card is also developed as an application programs. Therefore, the programs can be developed under an environment without operation system. Moreover, the computer system with parallel sever architecture is not of layer architecture. Therefore, the application programs can be restarted once the application programs are hacked.

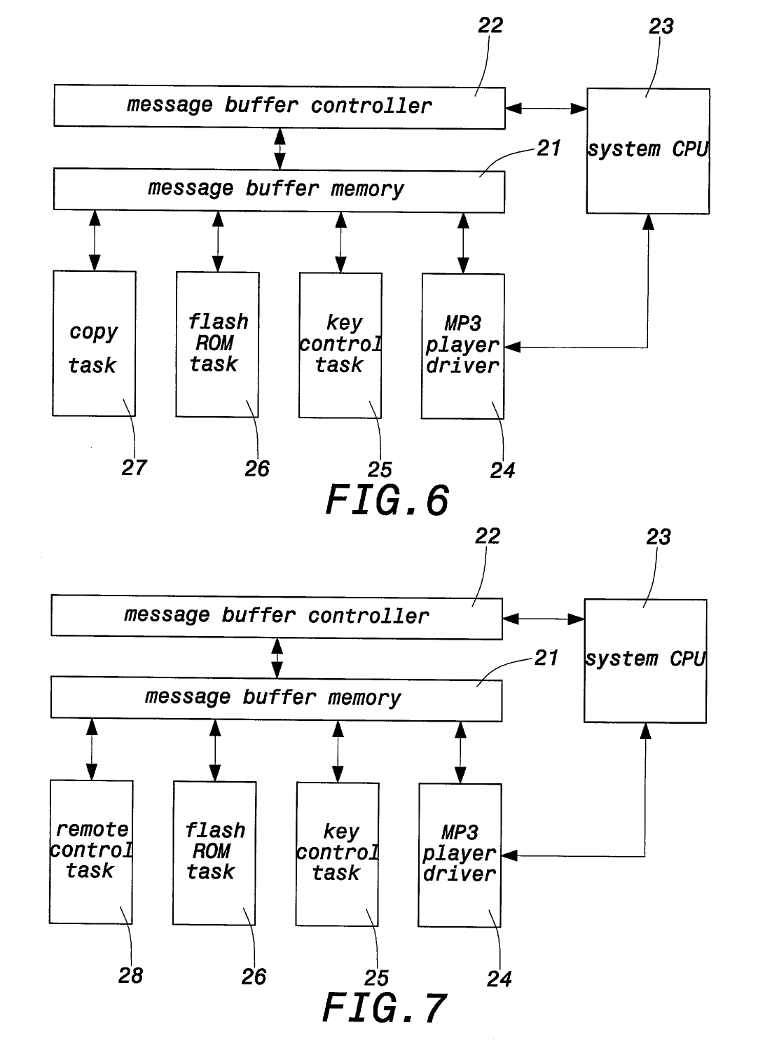

FIGS. 6, 7, and 8 show the preferred embodiment of the present invention, wherein an MP3 player is demonstrated. With reference also to FIG. 3, a message buffer memory 21 and a message buffer controller 22 are used to realize the function of the message exchange unit 11. The system CPU 23 is core chip of the whole system. Moreover, an MP3 player driver 24 is mounted to the message buffer memory 21. The MP3 player driver 24 is functioned as a service task and the common device driver unit 10 of the system. The MP3 player driver 24 further comprises an LCD interface for display function beside MP3 decoding chip. To simplify description, the function of the MP3 player driver 24 is focused on playing MP3 file.

To add more function to the MP3 player driver 24, a key control task 25 is added to the message buffer memory 21 for providing key function of play and stop. Therefore, system can provide play, stop and decoding function for MP3 file. Moreover, a flash ROM task 26 is added to the message buffer memory 21. Provided that an MP3 music file is stored in the flash ROM task 26, the system can be used to playback this MP3 music file.

Hereinafter, the detailed operation of the demonstrated system is described. At first, the key control task 25 senses the pressing operation of “play” key and generates a play command to the MP3 player driver 24 through the message buffer memory 21. Upon receiving the play command from the message buffer memory 21, the MP3 player driver 24 starts a preparation procedure such as initialization of playback chip. Afterward, the MP3 player driver 24 sends identification request to all tasks in this system through the message buffer memory 21. After all tasks replay their identifications to the MP3 player driver 24 through the message buffer memory 21, the MP3 player driver 24 finds that the flash ROM task 26 is a storage device and sends a reading request to the flash ROM task 26. Upon receiving the reading request of the MP3 player driver 24, the flash ROM task 26 sends a first frame of the MP3 file to the MP3 player driver 24 through the message buffer memory 21. The MP3 player driver 24 receives the first frame of MP3 file through the message buffer memory 21 and sends the first frame of MP3 file to a decoding chip and sends request to the flash ROM task 26 for next frame of the MP3 file. At the same time, the MP3 player driver 24 also waits for replaying signal from other tasks. By cycling these operations, the MP3 player driver 24 can execute MP3 playback.

When the key control task 25 senses the pressing operation of “stop” key, the key control task 25 generates a stop command to the MP3 player driver 24 through the message buffer memory 21. Upon receiving the stop command from the message buffer memory 21, the MP3 player driver 24 stops playback action and request to the flash ROM task 26 for more MP3 file. At this stage, the system stops MP3 playback action. In above-mentioned operations, the data sent from the flash ROM task 26 to the MP3 player driver 24 will not pass through the key control task 25 and the keystroke signal from the key control task 25 is also not sensed by the flash ROM task 26. In other word, the key control task 25 is isolated from the flash ROM task 26 and has no interaction with the flash ROM task 26.

If a hacker intends to steal the data in the flash ROM task 26 by adding a copy task 27 to the message buffer memory 21, his effort is in vain. The flash ROM task 26 simply replies request from the MP3 player driver 24 and does not communicate with the copy task 27. Moreover, the ROM task 26 only sends data to the MP3 player driver 24 and does not reply reading request from other tasks. The copy task 27 cannot access data from the ROM task 26. Therefore, the data sent to the message buffer memory 21 does not require encryption.

Similarly, if remote control function is to be added in this system, a remote control task 28 is added to the message buffer memory 21. The system has remote control and has schematic diagram as shown in FIG. 7. Obviously, the key control task 25 should have enough keyswitches to support remote control function. Moreover, if a hard disk driver (not shown) is to be added into this system, a hard disk driver task is added to the message buffer memory 21 as above-mentioned operation.

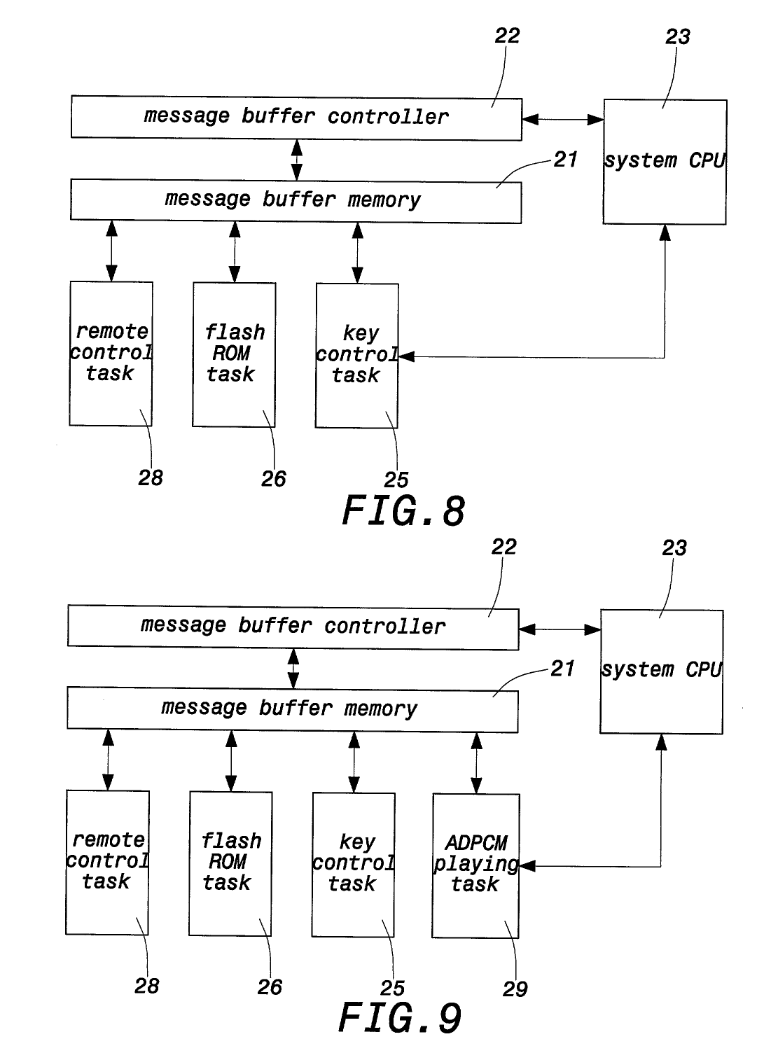

To further exploit this system, as shown in FIG. 8, the MP3 player driver 24 is removed. The system still can operate but generates no output. It can be manifested that the system can be restored to normal operation by restarting the MP3 player driver 24 once the MP3 player driver 24 is dumb. Moreover, as shown in FIG. 9, the MP3 player driver 24 is replaced by an ADPCM playing task 28, and the ADPCM file is stored in the ROM task 26. The system becomes an ADPCM player now. In the architecture of the present invention, the system has different or even enhanced functions by replacing or adding related tasks. The cost of research can be advantageously reduced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A computer system with parallel sever architecture, comprising a CPU, memory and I/O interface; the computer system further having:
a common device driver unit for managing the I/O interface of at least one common device of the computer system;
at least one application module unit runnable on the computer system and comprising hardware and software to perform certain function with the help of the common device in the common device driver unit; and
a message exchange unit functioned as message interface of the common device driver unit and the application module unit; wherein
the common device driver unit is in same hierarchy as each of the at least one application module unit, the communication between the common device driver unit and each of the at least one application module unit is controlled by the message exchange unit.

2. The computer system with parallel sever architecture as in claim 1, wherein each of the at least one application module unit has at least one personal device to perform specific function.

3. The computer system with parallel sever architecture as in claim 1, wherein the at least one application module unit can issue requests to the common device driver unit through the message exchange unit for accessing the common device, the common device driver unit schedules the requests and replies the requests by priority.

4. The computer system with parallel sever architecture as in claim 1, wherein each of the at least one application module unit further comprises an application memory and I/O map and a basic service routine device driver for providing auxiliary functions to access all service tasks provided by the common device driver unit.

5. The computer system with parallel sever architecture as in claim 1, wherein the common device driver unit can be integrated into a chip or modularized.

6. The computer system with parallel sever architecture as in claim 1, wherein the at least one application module unit can be integrated into a chip or modularized.

7. The computer system with parallel sever architecture as in claim 1, wherein the common device driver unit has a message exchange buffer to read request from the common device driver unit and send a reply to the common device driver unit.

8. The computer system with parallel sever architecture as in claim 1, wherein the at least one application module unit has a message exchange buffer to read request from the application module unit and send a reply to the application module unit.

9. The computer system with parallel sever architecture as in claim 1, wherein each of the at least one application module unit and the common device driver unit can not read data or execute program of each other without permission.
